(19) United States
(12) Patent Application Publication
(10) Pub. No.: US 2012/0270189 A1
(43) Pub. Date: Oct. 25, 2012

(54) Link Pencils

(76) Inventor: Christopher Joseph Price, (US)

(21) Appl. No.: 13/090,505

(22) Filed: Apr. 20, 2011

(51) Int. Cl. G09B 19/00; B43K 19/00

(52) U.S. Cl. 434/236; 401/49

(57) ABSTRACT

Link pencils, pens, or other writing utensils provide an improved method of discretely signaling special needs students in a class room setting. The invention utilizes radio frequency communication by using a transmitting device located inside of a writing utensil pencil that talks to a receiving device located inside a separate writing utensil. Once installed, there is no visible way to distinguish the modified pencils from ordinary pencils. The pencil containing the transmitting device is used by an instructor. The pencil containing the receiving device, which in some embodiments may be a transceiver such as a Bluetooth™ transceiver but without input to transmit a user controlled signal, is meant to be used by a student. When the instructor pushes down on the eraser or end of the writing utensil containing the transmitting device, the device containing the receiving device vibrates or emits light. This signals the student to pay attention.

### BACKGROUND OF THE INVENTION

1. Field of the Invention

This invention is in the field of wireless communication as it relates to educational materials, particularly with regards to special education.

2. Description of the Related Art

In educational settings, and particularly with regards to educational settings for special needs students, students with attention deficit disorders, and the like, often the instructor has a need to remind the student to focus on his or her studies.

This can cause problems, however. The act of being singled out by an instructor for inattention or other issues can be very embarrassing for the student. The student ends up feeling humiliated, and may end up resenting the instructor. Additionally, the concentration of the entire class may also be disrupted. The entire class begins to focus on the inattentive student, rather than the educational lesson at hand. The net effect is that an instructor intervention often does more harm than good.

There is little prior art regarding inconspicuous ways to urge students to focus on their work. Although previous workers, such as Striemer in U.S. Pat. No. 6,992,556 proposed wireless methods relating to monitoring and tracking students in a school setting, such methods tended to be relatively complex, conspicuous, and cumbersome to use. Thus further advances in the art are desirable.

### BRIEF SUMMARY OF THE INVENTION

The invention is based, in part, on the insight that what is needed in this situation is a way to gently remind the student to pay attention without otherwise doing anything else to call attention to the student. In this way, the reminder message may be received without alerting other class members that the instructor believed that the student was not performing optimally.

The invention is also based, in part, upon the insight that prior art solutions, such as pocket pagers, are suboptimal because a mild vibration signal in the pocket pager might easily not be perceived by the student, while a stronger vibration signal or audio signal might be too easily be perceived by nearby students, thus bringing unwanted attention and potential humiliation to the student.

The invention is also based, in part, upon the insight that students frequently write in class, and do so by way of writing utensils such as pens and pencils. These pens and pencils are typically held in the student's fingers, and fingers tend to be very sensitive to vibration. Further students also tend to frequently look at their writing utensils. Thus an attention getting device that operated at the level of the student's writing utensil would be able to generate inconspicuous signals that nonetheless would have a high chance of being reliably perceived by the student.

The invention is also based, in part, upon the insight that bidirectional communicating devices (i.e. a student attention getting device that could both send and receive) might offer too high an opportunity for cheating, and thus at least from a test security standpoint, might be less desirable. Thus regardless of any bidirectional handshaking needed to establish an infrared or radio link, such as an IrDA or Bluetooth™ radio link, the student's device should generally not be usable by the student to transmit messages, and in this respects the student's device should be considered to be a receiver only.

Thus in one embodiment, the invention may be a method of allowing an instructor to inconspicuously get the attention of a student. This method will often involve providing a receiver that is often shaped to resemble a writing utensil, such as a number 2 pencil to a student. Indeed the invention will in fact usually function as a writing utensil as well. The method will also provide the instructor or other supervisor with a transmitter. This transmitter may itself be configured to resemble a writing utensil, or alternatively may be configured to be some object. In some embodiments, the transmitter may be part of another device such as a laptop computer, pad, locket, cell phone, clicker, book or other device. According to the invention, the instructor may use the transmitter to send a first signal, such as a wireless radio signal, to the receiver. This will cause the pencil or pen based receiver to generate an inconspicuous signal, such as a vibration or light signal, thereby getting the invention of the student.

In an alternative embodiment, the invention may be a transmitter and receiver system. This system may comprise a wireless radio receiver configured to resemble a functional writing utensil (again often a pen or pencil), as well as a wireless radio transmitter. The transmitter itself may also resemble a writing utensil as well. The transmitter will further comprise an activation switch configured so that pressing the switch sends a wireless radio signal to the receiver. The receiver will generally also comprise a vibrator or light emitter (such as a light emitting diode), and will be configured so that upon detection of the wireless signal, the receiver will vibrate and/or produce light.

### BRIEF DESCRIPTION OF THE DRAWINGS

FIG. 1 shows one embodiment of the invention in use.

FIG. 2 shows an embodiment of the electronic circuits used to implement a prototype of the invention.

FIG. 3 shows an embodiment of the electronic circuits used to implement a prototype of the invention.

FIG. 4 shows a circuit board layout of a prototype of the receiver and transmitter components of the invention, which are designed to be inserted into standard Number 2 pencils.

### DETAILED DESCRIPTION OF THE INVENTION

As previously discussed, in one embodiment, the invention may be a method of allowing an instructor to inconspicuously get the attention of a student. This method will often involve providing a receiver, shaped to resemble a writing utensil, such as a number 2 pencil (and which in fact often will be a functional pencil or pen) to a student. The method will also provide the instructor or other student supervisor with a transmitter. This transmitter may itself be configured to resemble a writing utensil, or may be configured to be some object. In some embodiments, the transmitter may be part of another device such as a laptop computer, pad, locket, cell phone, clicker, book or other device. According to the invention, the instructor may use the transmitter to send a first signal, such as a wireless radio signal, to the receiver. This will cause the receiver to generate an inconspicuous signal, such as a vibration or light signal, thereby getting the invention of the student.

Note that although in many embodiments the transmitter will be a wireless radio transmitter, and the receiver will be a wireless radio receiver, and the first signal may be a wireless radio signal, other methods are also possible. For example, in some embodiments infrared or even ultrasonic signals may be transmitted from the receiver to the transmitter. In these embodiments, the transmitter will be an infrared or ultrasonic transmitter, and the receiver may be an infrared or ultrasonic transmitter. To prevent cheating, one way transmissions (e.g. transmitter to receiver) are generally preferred, and thus often at least the student's device will not be configured to allow the student to transmit messages, and thus will be designated a receiver. In some embodiments, both devices may be transceivers, capable of both transmitting and receiving. For high reliability communications, often both devices will incorporate transceivers capable of both transmitting and receiving, however since at least the student's device will normally not allow the student to transmit messages, the student device will be termed a receiver. Often also the teacher's device will not be configured to receive messages (at least beyond basic handshaking messages) from the student's device, and thus the teacher's device will be designated a transmitter. Examples of suitable infrared and radio transceivers which may be used for both the student and teacher's devices include bidirectional infrared or radio protocols and components, such as IrDA, Bluetooth or Zigbee™ transceivers. In some embodiments, exemplified by the prototype disclosed herein, unidirectional (one-way) transmitters and receivers may be used.

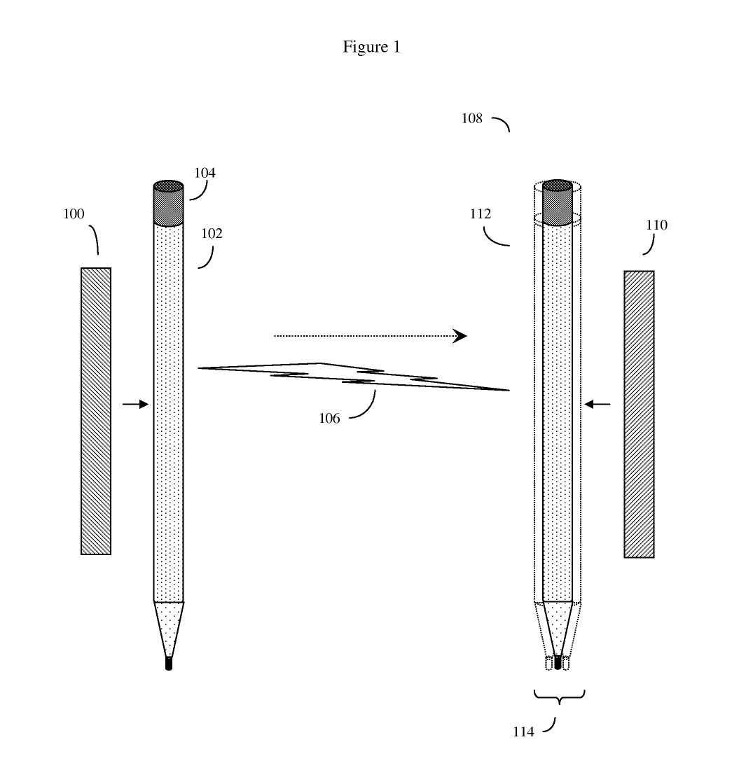

An example of an embodiment in which the invention is implemented in the form of circuit boards designed to be inserted into slots or openings drilled into standard number 2 pencils is shown in FIG. 1.

In this example, the transmitter circuit board (100) is inserted into an opening or slot in a writing utensil (102), such as a modified number 2 pencil. The pencil will usually still continue to operate as a pencil even after the modification. Here, upon detecting pressure on the eraser (104), the transmitter circuit board (100) will send a wireless signal (106) to the receiver device (108). The receiver device itself can be produced by inserting a receiver circuit board (110) into a slot or opening in another writing utensil, such as a different modified number 2 pencil (112). When the receiver receives a signal (106), the receiver will vibrate (114), or produce a light (not shown).

Returning to the wireless radio embodiment, many different frequencies and types of radio communication may be used. In some embodiments, longer wavelength or lower frequency radio, such as 433 MHz radio frequency, may be used. In other embodiments, shorter wavelength or higher frequency radio signals, such as the 2.4 GHz frequency range may be used.

A variety of different wireless transmission protocols may also be used. In some embodiments, the transmitter may transmit a simple carrier wave, producing a logical “high” when activated. In other embodiments, more sophisticated coding schemes may be used to allow a number of different transmitters and receivers to operate within wireless range of each other without interference. That is, each receiver may be programmed to only respond to radio transmissions that are sending that receiver's particular code.

The receiver may produce a variety of different outputs upon receiving a proper activation signal from the transmitter. As previously discussed, in some embodiments the receiver may have a vibration unit attached, designed to inconspicuously vibrate when a signal from the transmitter is detected. In other embodiments, the unit may have one or more light sources, such as a light emitting diode (LED) attached, so that the student may see light from the top, middle, or lower writing portion of the writing utensil when the instructor transmits a “pay attention” signal.

Although in a preferred embodiment, the transmitter will also be designed to fit in a writing utensil such as a pen or pencil, other transmitter embodiments are also possible. In alternative embodiments, the transmitter may exist in the form of a device designed to attach to a laptop computer, desktop computer, smart tablet, smart phone, or other computerized device so that the instructor can instruct the computerized device to act as a transmitter. Thus for example, in an embodiment where the receiver writing utensil operates using a Bluetooth™ or other type short range transceiver, the instructor may activate the receiver using his or her laptop computer, tablet computer, desktop computer, smart phone, or other device. Here the receiving writing utensil will still be designated a receiver because other than communicating to the minimal extent necessary to establish a Bluetooth or other type connection, the receiver will not otherwise transmit useful information.

As yet another embodiment, the transmitter may be designed in the form of a wristwatch, locket, or other item of personal jewelry designed to be worn by the instructor.

In the preferred embodiment form in which the transmitter is also a writing utensil (e.g. pencil or pen), the pencil or pen may be designed so that the activation switch is located near the top of the device, in a location corresponding to the eraser portion of the device or the pen engagement button of the device. Thus in this embodiment, the instructor may activate the transmitter by merely appearing to press on the top of his or her writing utensil.

Returning to the problem of operating multiple such devices in a school environment, where more than one student may have a receiver device, as previously discussed, in alternative embodiments of the invention, the device may be designed so that each receiver may respond to either a unique frequency or a unique identification code. Here for example, when Bluetooth transceivers are used, the standard Bluetooth pairing commands will operate with sufficient precision to distinguish one device from another device.

Alternatively or additionally, in order to more readily tune the transmitters and receivers to properly respond to each other, the devices may be equipped with either a small electrical contact, such as a mini-USB plug, or other type of miniature plug, or with a small electrical switch which allows the code or frequency to be assigned. In an alternative embodiment, the devices may also be programmed by a wireless programmer, which may send a wireless radio signal, inductive signal, or other type of signal into the device to assign it a particular frequency and/or transmission code and reception code.

The electrical circuits on both the receiver and transmitter will normally require a source of electrical power. Here this source will most normally be a rechargeable battery, such as a lithium ion battery or other type battery. In order to facilitate charging, a battery charging interface and adapter may also be provided.

In some embodiments, the battery charging interface can be a simple metal-to-metal contact interface, such as inconspicuous metal contacts mounted on the sides of the writing utensil device. In other embodiments, the battery charging interface can be hidden. For example, in some embodiments, the battery may be connected to an induction coil, which may in turn be invisible from the outside. In this example, the entire writing utensil may be placed in an inductive coil charger, and charged in much the same way that an electric toothbrush may be charged by placing in an induction charger.

### Examples and Prototype:

In this embodiment, which is a prototype of the invention, the invention utilizes radio frequency communication by using a transmitting device located inside of a number two pencil. This transmitter transmits to a receiving device located inside a separate number two pencil. Once installed, there is no visible way to distinguish the modified pencils from ordinary pencils. The pencil containing the transmitting device is meant to be used by an instructor. The pencil containing the receiving device is meant to be used by a student. When the instructor pushes down on the eraser of the pencil containing the transmitting device, the pencil containing the receiving device vibrates. This signals the student to pay attention.

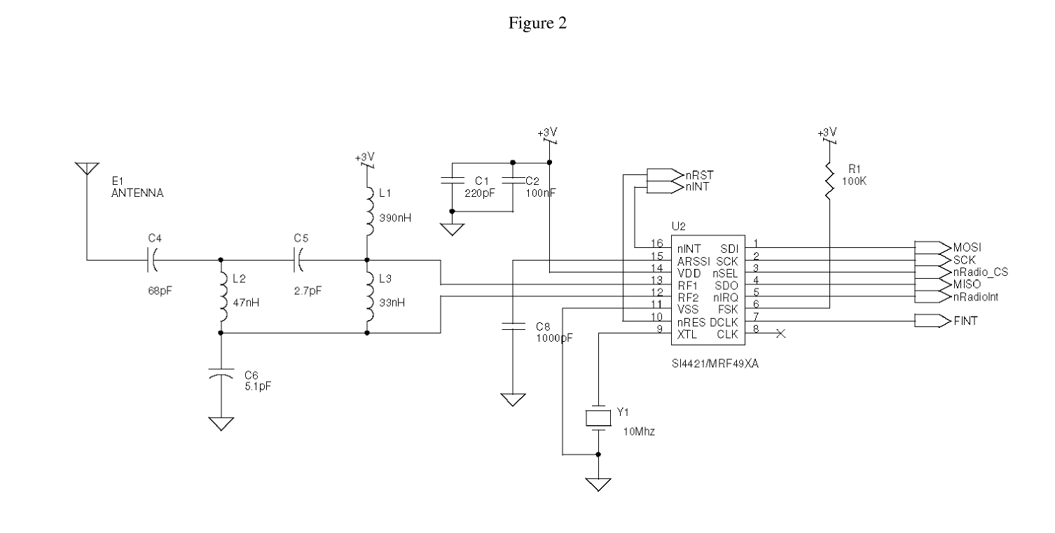

Thus in this embodiment, the invention may be a system of two devices, a transmitter device and receiver device, both used in tandem for discrete communications. Both devices may be based on a unique circuit board design, similar to that shown in FIGS. 2, 3, and 4, which is able to fit inside drilled out number 2 pencils.

The invention possesses numerous advantages to common methods of discrete communications. In particular, the invention may utilizes a single vibrator motor on the receiver device, or alternatively a light emitting diode, which allows instructors to gain the attention of special needs students without drawing unnecessary attention, thereby allowing an improved learning environment. Moreover, once installed there is no visible way to distinguish the host pencils from regular pencils.

As previously discussed, one advantage of implementing the invention in the form of a pair of radio frequency linked inserts designed to be placed inside drilled out number 2 pencils, pens, or other writing utensils is that the inserts can be transferred from one writing utensil to another when the ink or lead (graphite) of the writing device is used up.

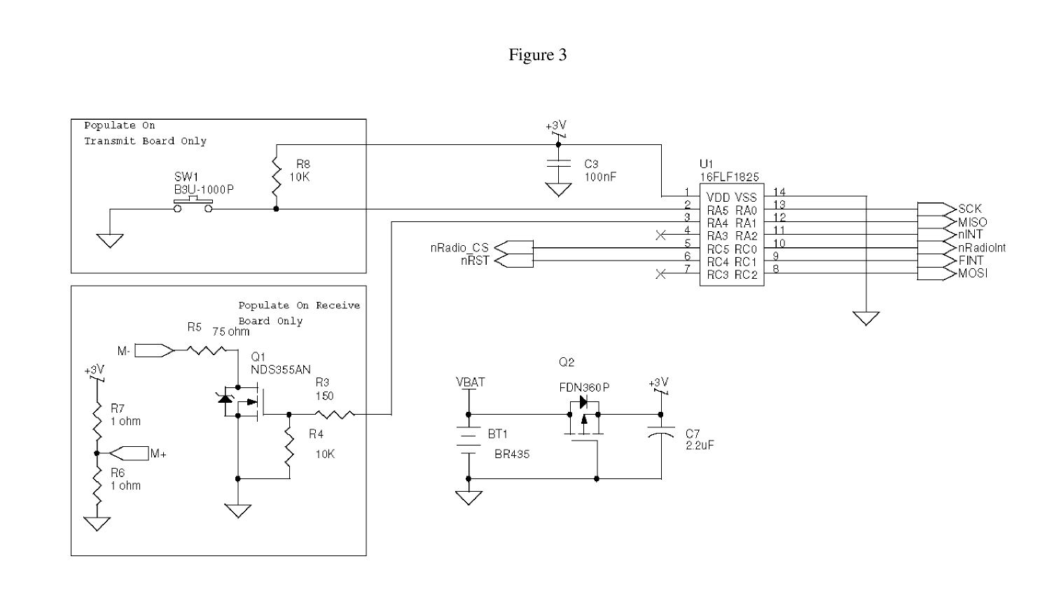

The circuit diagram for this particular prototype is shown in FIG. 2 and FIG. 3.

As previously discussed, the transmitter device may be configured to transmit a simple on/off type signal, or a more complex coded signal as desired. The button labeled BT1 in FIG. 3 allows current to pass through the circuit when pressed. This causes a carrier frequency to be transmitted through an antenna, which attaches in FIG. 2 as E1. While the carrier frequency is being transmitted (which is done by holding down BT1), the receiver device triggers a vibrator motor, represented in FIG. 2 as the letter M.

The various components in this example are as follows:

### Quantity: 1

Reference designator: C1

### Description: CAP CER 220 PF 50V 5% COG 0402

### Manufacturer: Murata

Manufacturer part number: GRM1555C1H221JA01D

### Quantity: 2

Reference designator: C1, C3

### Description: CAP CER 220 PF 50V 5% COG 0402

### Manufacturer: Murata

Manufacturer part number: GRM155R71H103KA88D

### Quantity: 1

Reference designator: C4

### Description: CAP CER 68 PF 50V 5% COG 0402

### Manufacturer: Murata

Manufacturer part number: GRM1555C1H680JZ01D

### Quantity: 1

Reference designator: C5

### Description: CAP CER 5.1 PF 50V COG 0402

### Manufacturer: Murata

Manufacturer part number: GRM1555C1H2R7CZ01D

### Quantity: 1

Reference designator: C6

### Description: CAP CER 5.1 PF 50V COG 0402

### Manufacturer: Murata

Manufacturer part number: GRM1555C1H5R1DZ01D

### Quantity: 1

Reference designator: C7

### Description: 1 CAP TANT 2.2UF 10V 10% SMD

### Manufacturer: KEMET

Manufacturer part number: T491A225K010AT

### Quantity: 1

Reference designator: C8

### Description: CAP CER 1000 PF 50V 10% X7R 0402

### Manufacturer: Murata

Manufacturer part number: GRM155R71H102KA01D

### Quantity: 1

Reference designator: L1

### Description: INDUCTOR MULTILAYER 390NH 0402

### Manufacturer: TDK

Manufacturer part number: MLG1005SR39J

### Quantity: 1

Reference designator: L2

### Description: INDUCTOR MULTILAYER 47NH 0402

### Manufacturer: TDK

Manufacturer part number: MLG1005S47NJ

### Quantity: 1

Reference designator: L3

### Description: INDUCTOR MULTILAYER 33NH 0402

### Manufacturer: TDK

Manufacturer part number: MLG1005S33NJ

### Quantity: 1

Reference designator: Q1

### Description: 1MOSFET N-CH 30V1.7A SSOT3

### Manufacturer: FAIRCHILD SEMI

Manufacturer part number: NDS355AN

### Quantity: 1

Reference designator: Q2

### Description: 1MOSFET P-CH 30V 2A SSOT3

### Manufacturer: FAIRCHILD SEMI

Manufacturer part number: FDN360P

### Quantity: 1

Reference designator: R1

### Description: 1 RES 100K OHM 1/10W 1% 0603

### Manufacturer: PANASONIC

Manufacturer part number: ERJ-3EKF-1003V

### Quantity: 1

Reference designator: R3

Description: 1 RES 150 OHM 1/10W 1% 0603

### Manufacturer: PANASONIC

Manufacturer part number: ERJ-3EKF1500V

### Quantity: 2

Reference designator: R4, R8

### Description: 2 RES 10K OHM 1/10W 1% 0603

### Manufacturer: PANASONIC

Manufacturer part number: ERJ-3EKF-1002V

### Quantity: 1

Reference designator: R5

### Description: RES 75 OHM 1/10W 1% 0603

### Manufacturer: PANASONIC

Manufacturer part number: ERJ-3EKF75R0V

### Quantity: 2

Reference designator: R6, R7

### Description: RESISTOR 1.00HM1/10W 5% 0402

### Manufacturer: PANASONIC

Manufacturer part number: ERJ-2GEJ1R0X

### Quantity: 1

Reference designator: SW1

### Description: SWITCH TACT SPST W/O GND SMD

### Manufacturer: OMRON

Manufacturer part number: B3U-1000P

### Quantity: 1

Reference designator: U1

### Description: IC, DIGITAL MICROCONTROLLER

### Manufacturer: MICROCHIP

Manufacturer part number: PIC16F1825-I/ST

### Quantity: 1

Reference designator: U2

### Description: IC RF TXRX 433/868/915 16-TSSOP

### Manufacturer: MICROCHIP

Manufacturer part number: MRF49XA-UST

### Quantity: 1

Reference designator: Y1

### Description: CRYSTAL 10.0000 MHZ 10 PF SMD

### Manufacturer: ABRACON

Manufacturer part number: ABM3B-10.000 MHZ-10-1-U-T

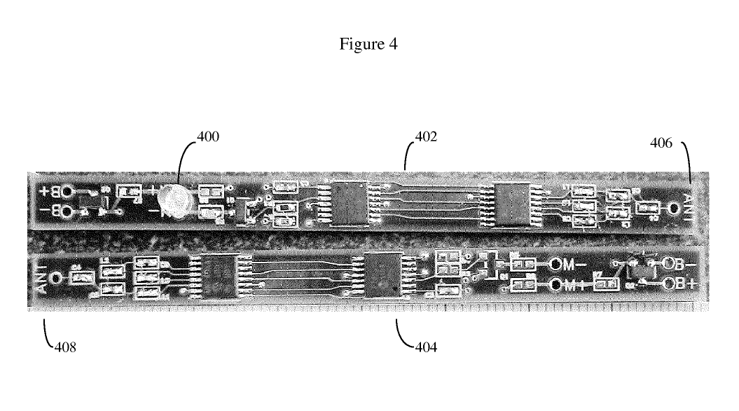

FIG. 4 shows a top view of the prototype transmitter and receiver insert device. This device was implemented in a surface mount Gerber circuit board design produced using standard RS274X format code. In FIG. 4, all of the various surface mount components are also installed.

In this example, instead of using a vibrator motor, a light emitting diode was used. This is shown as (400). The receiver insert is shown as (402), and the transmitter is shown as (404). Both use a small wire for the antenna, which is attached at the holes labeled “ANT” (406, 408). The battery and transmitter switch are not shown.

1. A method of allowing an instructor to inconspicuously get the attention of a student, said method comprising,
providing a receiver shaped to resemble a writing utensil to a student; and
providing the instructor with a transmitter; and
using said transmitter to send a first signal to said receiver, causing said receiver to generate an inconspicuous second detectable signal, thereby getting the attention of the student.

2. The method of claim 1, wherein said writing utensil is a functional pen or pencil.

3. The method of claim 2, wherein said writing utensil resembles a standard number 2 pencil.

4. The method of claim 1, wherein said first signal is a wireless radio signal, infrared signal, or ultrasonic signal.

5. The method of claim 4, wherein said receiver comprises a Bluetooth receiver.

6. The method of claim 1, wherein said inconspicuous second detectable signal is a vibration signal.

7. The method of claim 1, wherein said inconspicuous second detectable signal is a visible light signal.

8. The method of claim 1, wherein said inconspicuous second detectable signal is a low intensity audio signal.

9. The method of claim 1, wherein said transmitter has a top end and a bottom writing end, and is shaped to resemble a functional pen or pencil.

10. The method of claim 1, further directing said transmitter to send said first signal by pressing a switch located on said top end.

11. The method of claim 1, wherein said transmitter transmits on either a unique frequency and/or using a unique transmitter specific code, and said receiver receives on either said unique frequency or using said unique receiver specific code.

12. The method of claim 11, further providing an electrical connection, wireless connection, inductive connection, or mechanical switch on said transmitter and said receiver so that said transmitter and said receiver may be adjusted to the same frequency and/or same specific code.

13. The method of claim 1, wherein said transmitter and said receiver are configured with a rechargeable battery.

14. The method of claim 13, wherein said rechargeable battery may be recharged with a wired or wireless induction recharger.

15. A method of allowing an instructor to inconspicuously get the attention of a student, said method comprising,
providing a wireless radio receiver shaped to resemble a writing utensil to a student; and
providing the instructor with a wireless radio transmitter;
using said transmitter to send a first wireless radio signal to said receiver, causing said receiver to generate a vibration or light signal, thereby getting the attention of the student;
wherein said transmitter transmits on either a unique frequency and/or using a unique transmitter specific code, and said receiver receives on either said unique frequency or using said unique receiver specific code;
wherein at least said receiver is configured with a rechargeable battery;
and wherein said rechargeable battery may be recharged with a wired or wireless induction charger.

16. The method of claim 15, in which both said receiver and said transmitter resemble a functional pen or pencil.

17. The method of claim 15, wherein at least said receiver is configured with an electrical connection, wireless connection, inductive connection, or mechanical switch so that said transmitter and said receiver may be adjusted to the same frequency and/or same specific code.

18. A transmitter and receiver system;
said system comprising a wireless radio receiver configured to resemble a functional writing utensil, and a wireless radio transmitter;
said transmitter further comprising an activation switch configured so that pressing said activation switch sends a wireless radio signal to said receiver; and
Said receiver further comprising a vibrator and/or light, and wherein upon receiving said signal, said receiver vibrates and/or produces light in response to said signal.

19. The system of claim 18, wherein said wireless radio receiver and wireless radio transmitter each additionally comprise an electrical connection, wireless connection, inductive connection, or mechanical switch so that said transmitter and said receiver may be adjusted to the same frequency and/or same specific code.

20. The system of claim 18, wherein at least said receiver comprises a rechargeable battery, and a wired or induction wireless connection to an external charger.
